(19) United States
(12) Patent Application Publication
(10) Pub. No.: US 2015/0095256 A1
(43) Pub. Date: Apr. 2, 2015

(54) METHOD AND DEVICE FOR TRANSPORTING OBJECTS OF DIFFERENT TYPES TO DESTINATIONS

(71) Applicant: Siemens Aktiengesellschaft, Munchen (DE)

(72) Inventor: Ulrich Martin, Konstanz (DE)

(21) Appl. No.: 14/398,906

(22) PCT Filed: May 13, 2013
(86) PCT No.: PCT/EP2013/059789

§ 371 Date: Nov. 4, 2014

(30) Foreign Application Priority Data
May 22, 2012 (DE) 10 2012 208 578.5

(51) Int. Cl. G06Q 10/08

(52) U.S. Cl. CPC G06Q 10/08355
USPC 705/338

(57) ABSTRACT

A method and a device for transporting objects of different types to different destinations, in particular postal items to delivery addresses. Each object to be transported belongs to one of at least two different object types. For each object, the destination (Zp.1, Zp.2) of the object is determined. Each object is transported to its destination (Zp. 1, Zp. 2) and removed there. The transport device has a respective accommodation area for each object type. A data processing device (Mob) is carried during the transport. That device (Mob) displays, in a human-ascertainable form on a screen device (Bsg), the destinations (Zp.1, Zp. 2) to which objects are to be transported, and the object types for the particular destination (Zp. 1, Zp.2).

### CROSS-REFERENCE TO RELATED APPLICATIONS

The present application is a 35 U.S.C. §§371 National Phase conversion of PCT/EP2013/059789, filed May 13, 2013, which claims priority of German Patent Application No. 10 2012 208 578.5, filed May 22, 2012, the contents of which are incorporated by reference herein. The PCT International Application was published in the German language.

### TECHNICAL FIELD

The invention relates to a method and a device for transporting objects of different types to destinations, for example letters and parcels to delivery addresses.

### TECHNICAL BACKGROUND

US 2011/0029233 A1 describes a method of how a mail deliverer is guided by a mobile device he carries when delivering mail items. A description of a delivery point (a mail address) is displayed on a screen of the device. The deliverer travels to this delivery point. One or a number of mail items are to be delivered to this delivery point. An image of each mail item to be transported to this delivery point is displayed on the screen of the mobile device. In one embodiment, the images are displayed in series so that the impression of a stack of flat mail items appears on the screen. The display also shows how many mail items are to be delivered to this delivery point.

US 2005/0131576 A1 describes a “mail delivery support system”. A “central station 3” is connected by means of a “telecommunication link” to a number of mobile “peripheral units 7”, see FIG. 1. A central “mail sorting system 15” sorts mail items. An “image acquisition system 17” generates computer-accessible images of mail items. A “route planning system 19” generates “mail delivery routes” and approach routes to and return routes from these “mail delivery routes”. A “peripheral unit 7” has a CPU 50, a “video terminal 51” and an “alphanumeric keyboard 52”, see FIG. 2. In step 130 in FIG. 3, information on the number and the characteristics of containers with mail items is sent to the “peripheral unit 7” and stored locally and displayed on the “terminal 51”. In step 150, information on the number and types of mail items to be delivered to the next delivery point is displayed. On a user's request, an image of a mail item is displayed on the “terminal 51”.

It is often necessary to transport different objects to a delivery point, that is objects with significantly different dimensions or other different physical properties. For example, standard letters, large letters, small packets and parcels are to be delivered to the same delivery point. It would be impossible, or at least uneconomical, for one universal sorting system to sort all these different objects and one means of transportation to carry all these different objects.

It was therefore suggested that objects of one type be sorted together. Subsequently, and still before delivery, in each case a single overall sequence (“merging”) is created from a number of sequences of presorted objects of one object type. This “merging” of a number of sequences requires a separate operation and takes time.

The invention is based on the object of providing a method and a device for transporting objects of different types to different destinations without requiring a universal sorting system capable of sorting all object types and without it being necessary to carry out a “merging” of a number of sequences of sorted objects and without it being necessary to carry out a time-consuming search at every destination for objects for this destination.

Several objects are to be transported to different specified destinations. At least two object types are specified. Each object to be transported belongs to a specified object type. At least one first object of a first object type and at least one second object of a second object type are to be transported. It is possible that several objects of the first object type or several objects of the second object type are to be transported. It is also possible that objects of three or even more object types are to be transported to different destinations. It is furthermore possible that only objects of the first object type are to be transported to individual destinations, only objects of the second object type are to be transported to further destinations and objects of both object types are to be transported to other destinations.

A means of transportation is used to transport the different types of objects to the different destinations. This means of transportation has in each case at least one accommodation area for each object type. It is possible for two spatially separate accommodation areas to be provided for one object type in the means of transportation. The objects of this object type to be transported can be placed in or on the or an accommodation area for this object type in each case.

The destination to which an object is to be transported is determined for each object. All objects to be transported are placed in the same means of transportation. Therefore, the means of transportation contains objects of different types. This step is performed such that each object is placed in or on the accommodation area for this object type. Therefore, when loading the means of transportation, a decision is made for each object as to which object type this object is. The objects to be transported are divided between the accommodation areas in the means of transportation according to their respective object type.

The means of transportation with the objects travels in succession to the destinations. At each destination, all—or at least some—objects for this destination are removed again from the means of transportation. It is possible for objects of different types to be removed from different accommodation areas at the same destination.

A data-processing device is carried along on the journey of the means of transportation to the destinations. This device can be portable or installed in the means of transportation. The device is able to output information in a human-ascertainable form, for example pictorially or graphically on a screen device or by voice output. Humans require at least one of their five senses, but no technical aids, to obtain the information output according to the invention.

At least the following information is automatically sent to the device carried along:
To which destinations is at least one object to be transported in each case?
For each destination and each object type: Is no object or is at least one object of this object type to be transported to this destination?

The sent information is displayed on the data-processing device or output in another way, and, to be precise, in a form accessible to a human.

The invention makes it possible to transport objects of different types to their respective destinations with the same means of transportation during one transport operation. It is not necessary to mix objects of different object types (“merging”), for example according to the destinations of the objects. In particular, the invention means it is not necessary to create an overall sequence from all the objects of different types, wherein all objects are sorted in accordance with a specified order according to the destinations. Hence, the invention does away with the need for “merging”. “Merging” of this kind would in particular be cumbersome if the different types of objects have very different dimensions.

The invention also does away with the need to provide a separate accommodation area for each destination, for example in a sorting system, and to place or position all objects for this destination on this supporting area and to perform this step in succession for each object type. This would as a rule be very uneconomic because there are many more different destinations than object types.

According to the solution, the means of transportation used for transporting in each case comprises an accommodation area for each object type. Each object is placed on an accommodation area for this object type. This accommodation area is located in or on the means of transportation.

The information as to which object type or which object types the objects to be transported to a destination belong is output in a human-ascertainable form. The output information restricts the search for an object or for all objects for a destination to specific types of object. The embodiment with the different accommodation areas also facilitates the search in the means of transportation. This embodiment makes it easier to find an object of a specific object type. The search for the object can be restricted to the accommodation area or accommodation areas for this object type.

The different accommodation areas enable different identification systems to be used to output the information as to where all the objects for a specific destination are located. This respective identification system can, for example, be adapted to the different dimensions or superficial properties of the objects.

The invention does away with the need to have all objects to be transported sorted by a universal sorting system. Instead, it makes it possible in each case for each object type to use a sorting system of this kind which is tailor-made for this object type. It is also possible to have the objects of one object type sorted by one specialized sorting system and the objects of a second object type not sorted at all or sorted by hand.

In one embodiment, in each case, for each object type a sorting system is used which is tailor-made for this object type and therefore achieves a greater throughput than that with a universal sorting system. The journey of the means of transportation commences at a collecting point. This collecting point is, for example, a distribution center for mail items. Each sorting system has several sorter exits, including at least one sorter exit which is assigned to this collecting point. Each sorting system distributes the objects supplied to its sorter exits and diverts the objects into these sorter exits. All or at least some of the objects which are diverted into a sorter exit assigned to the collecting point are transported by the respective sorting system to said collecting point. In the collecting point, each object is placed in an appropriate accommodation area in the means of transportation accordingly to its object type. The loaded means of transportation then travels to the destinations.

In one embodiment, the data-processing device outputs the information on the objects which are to be transported to a destination during the journey to this destination. In another embodiment, the data-processing device outputs this information when the means of transportation has reached the destination.

In one embodiment, each object to be sorted passes through at least one system with a reading device. This reading device determines the respective destination to which the object is to be transported. For example, the reading device decodes an identification or a code for the destination on the actual object. Or the reading device decodes a unique identification for the object (“ID code”), and information on this object is determined in a database, said information being stored together with the decoded object identification, including an identification of the destination. It is determined for each destination determined or each destination from a specified range of destinations whether at least one object or even no object is to be transported to this destination.

In one embodiment, before starting the journey of the means of transportation, it is determined to which destinations in each case at least one object is actually to be transported. After the determination of the destinations, a route is automatically created containing the destinations that actually occur. An encoding of the calculated route is sent to the data-processing device. During the transportation of the objects, the data-processing device outputs the next destination in this route sent in each case and, to be precise, in a human-ascertainable form. Therefore, the route determined functions as a nominal line of travel for the means of transportation.

In one embodiment, the numbers of objects of each object type which are to be transported to a destination is additionally determined for each destination and for each object type. These numbers are output by the data-processing device in a human-ascertainable form. This embodiment makes it easier to find all objects for a destination in the respective accommodation area in the means of transportation. The risk of an object in the means of transportation being forgotten at the destination is reduced.

In one embodiment, an order of the destinations to which the objects are to be transported is specified or calculated. For example, a route planner automatically calculates a route including all destinations of objects that occur. The objects of at least one object type are put into sequence such that the sequence of the objects corresponds to the specified or calculated order of destinations. This sorting according to a specified order of destinations may be performed using a sorting system, which specializes in this object type. This sorting system does not necessarily also have to be able to sort objects of another object type. The sorted objects are placed on the accommodation area for this object type. It is easy to find an object for a specific destination in the sequence. It is possible for all objects of an object type to be put in an order according to the destinations while the objects of another object type are not put in order.

In one embodiment, the data-processing device outputs the information on the destinations and objects on a screen device, for example in text form or graphically. For example, specified symbols for the object types of a destination are displayed. In another or an additional output form, the information on the objects and destinations are output by voice output, similarly to the voice output from a satnav for a car driver. This embodiment enables the information to be output to a driver of the means of transportation during the journey without an output on a screen device distracting the driver.

In one embodiment, the data-processing device—or the means of transportation in or on which the data-processing device is located—constantly measures its current position. The data-processing device shows on a screen device a section from a map such that the current position of the means of transportation with the device can always be seen at a specific place in the section depicted, for example in the middle. If the section shown contains destinations to which objects are to be transported, at least one of these destinations, preferably at least the next destination to be approached, is also shown, and to be precise in the section shown.

In one embodiment, the data-processing device outputs for each destination and each object type the information as to how many objects of this object type are to be transported to this destination. It is also possible for the number zero to be output. This information makes it easy, for example for a delivery driver, to actually remove all objects for a destination from the means of transportation. As a result of the information output, it is known for each accommodation area and for each destination how many objects in the accommodation area for an object type should be sought and removed.

The means of transportation is for example a road vehicle (car or transporter), an aircraft, a ship or also a driveless vehicle, which is pushed or pulled by a human or even a container with number of accommodation areas, which humans drive or carry with them.

In one embodiment, the means of transportation is a vehicle and the data-processing device is installed in the vehicle, for example like a satnav system in a car. The information on the objects can be sent wirelessly, for example by a mobile radio system or via a mobile data carrier, for example by means of a CD or a USB memory, to this installed device.

In another embodiment, the data-processing device is a mobile portable device, for example a cell phone, a smartphone, a “personal Digital Assistant” (PDA) or a “tablet PC”. Once again, the information on the objects can be sent wirelessly, for example by a mobile radio system or via a mobile data carrier or also by means of a “docking station” to this portable device. This embodiment makes it possible for information to be sent to the device from outside the vehicle and for a “docking station” or a mobile data carrier, for example, to be used.

The objects to be transported are for example mail items, parcels, travelers' baggage or even workpieces in a production facility.

The invention is described below with reference to an exemplary embodiment. The drawings show:

### BRIEF DESCRIPTION OF THE DRAWINGS

FIG. 1 shows a schematic view of a logistics system with three sorting systems FIGS. 1A, 1B and 1C, and, a distribution center and a delivery vehicle;

FIG. 1D is a schematic view of a logistics network including the three sorting systems

FIG. 2 a central data-processing system with a route planner;

FIG. 3 a mobile data-processing device;

FIG. 4 an embodiment of the device in FIG. 3 with a standard mode which outputs the mail items that occur and a detail-mode which displays the numbers for each type;

FIG. 5 another embodiment of the device in FIG. 3, with which, in detail-mode, the numbers for each mail item type and for each floor of an apartment building are shown;

FIG. 6 a modification of the embodiment in FIG. 5, with which the names of the recipients are additionally output.

### DESCRIPTION OF EMBODIMENTS

In the exemplary embodiment, the invention is used to sort and transport different types of mail items. A mail carrier transports different types of mail items and delivers these mail items to their respective destinations, for example standard size letters, large size letters, postcards, catalogs, journals, small packets and parcels. Each mail item is provided with the names of the recipient and an identification of the destination, i.e. with a mail address (street and house number or post-office box or parcel compartment, mail code or ZIP code, location) or the geographical coordinates of a point on the earth's surface. This information is applied to the mail item by the shipper of the mail item or during transportation. The destination identification in a human-readable form makes a mail deliverer's work easier and enables a recipient to check the exterior of the mail item.

In the exemplary embodiment, different sorting systems are used, namely in each case one class of sorting systems for one type of mail item. The differentiation between object types (here: the types of mail items) depends upon which mail items a sorting system of one class is able to process. For example, a first class of sorting systems is for standard letters (“letter sorting machines”), a second class for large letters, journals and catalogs (“flats sorting machines”) and a third class for small packets and parcels (“parcel sorting machines”). It is also possible for different receiving stations to be used for the different types of mail items.

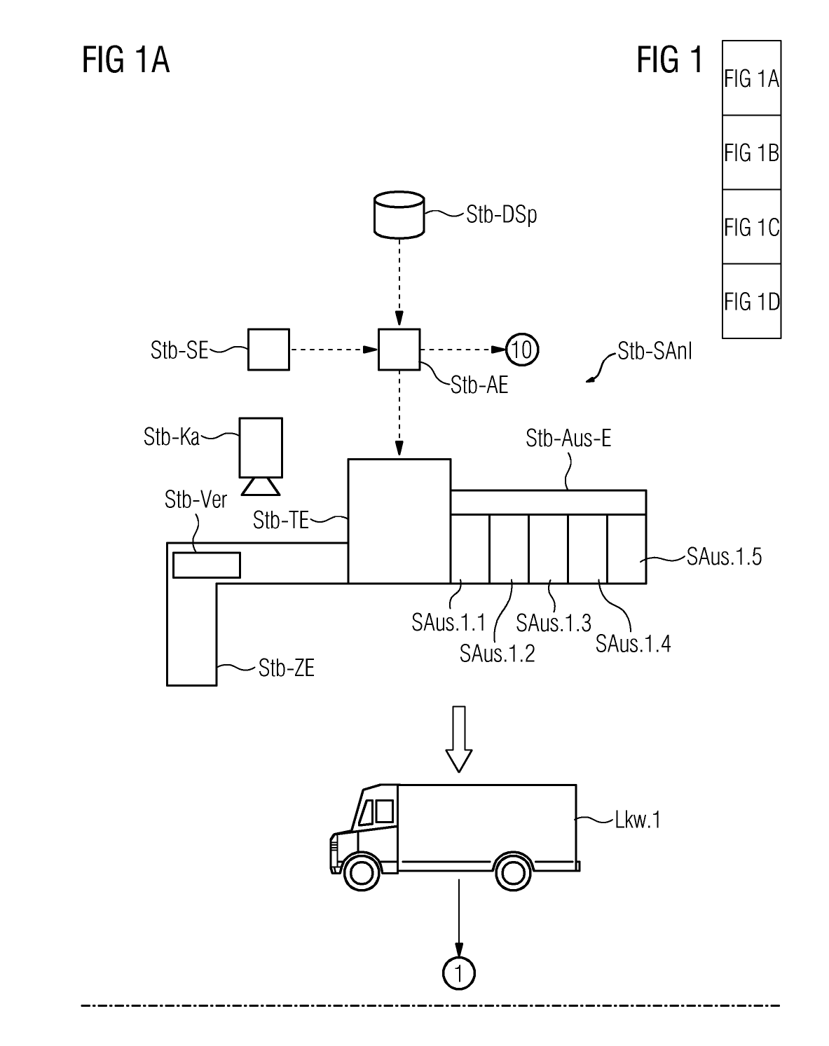

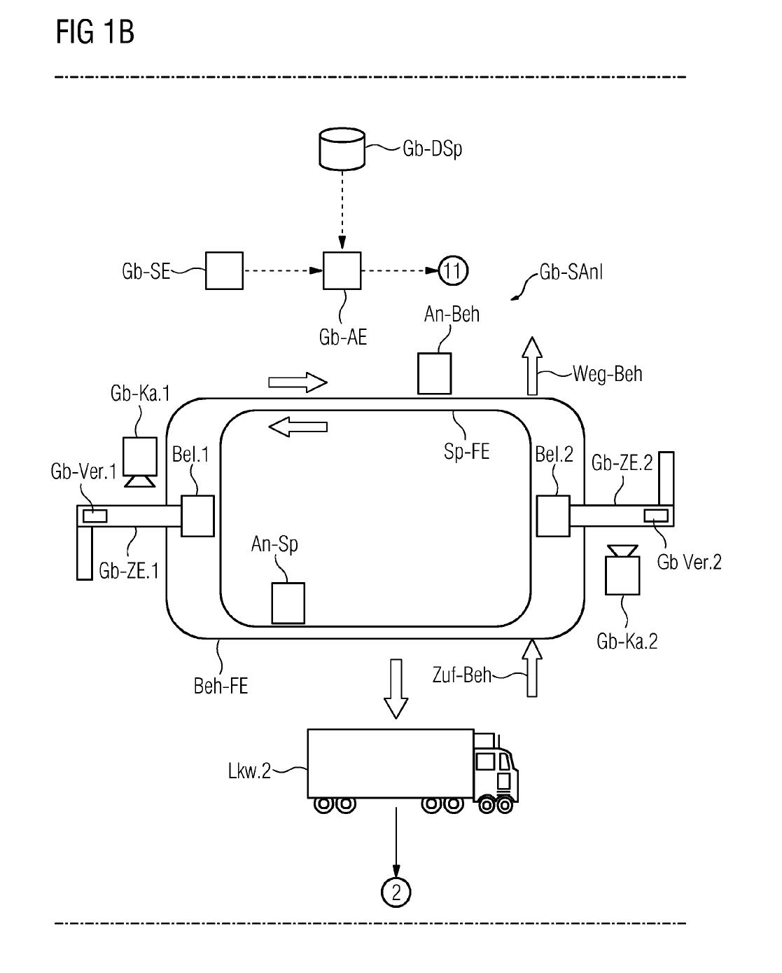

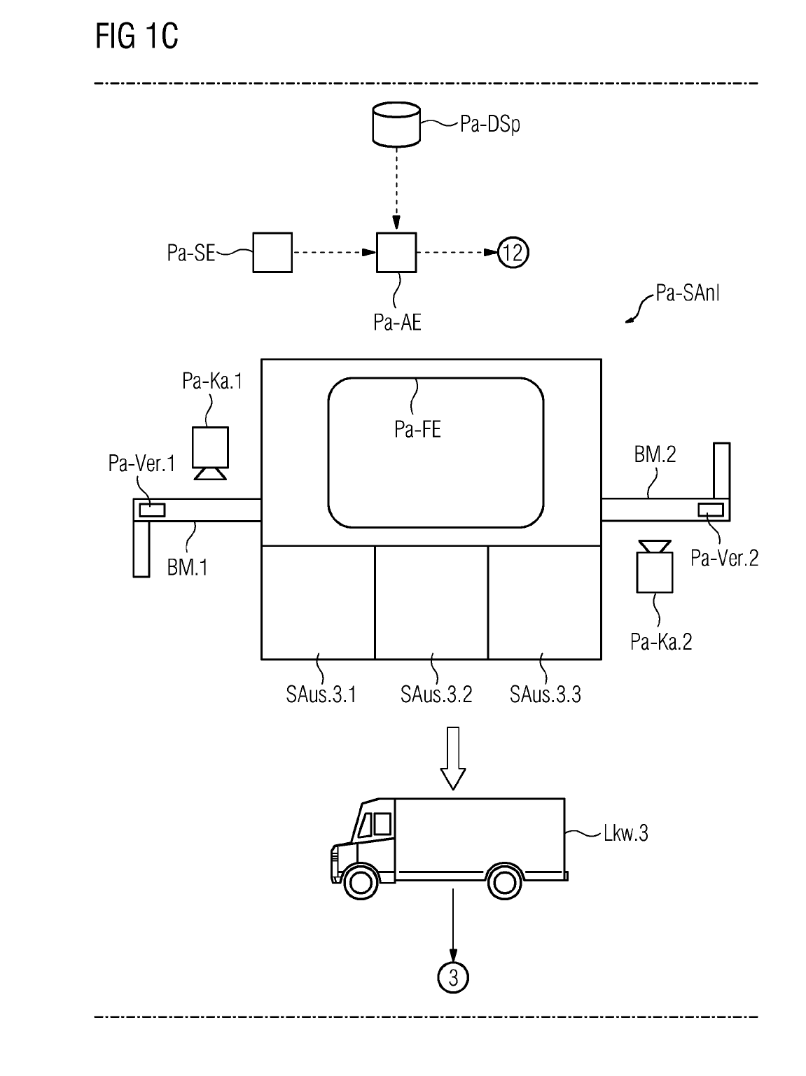

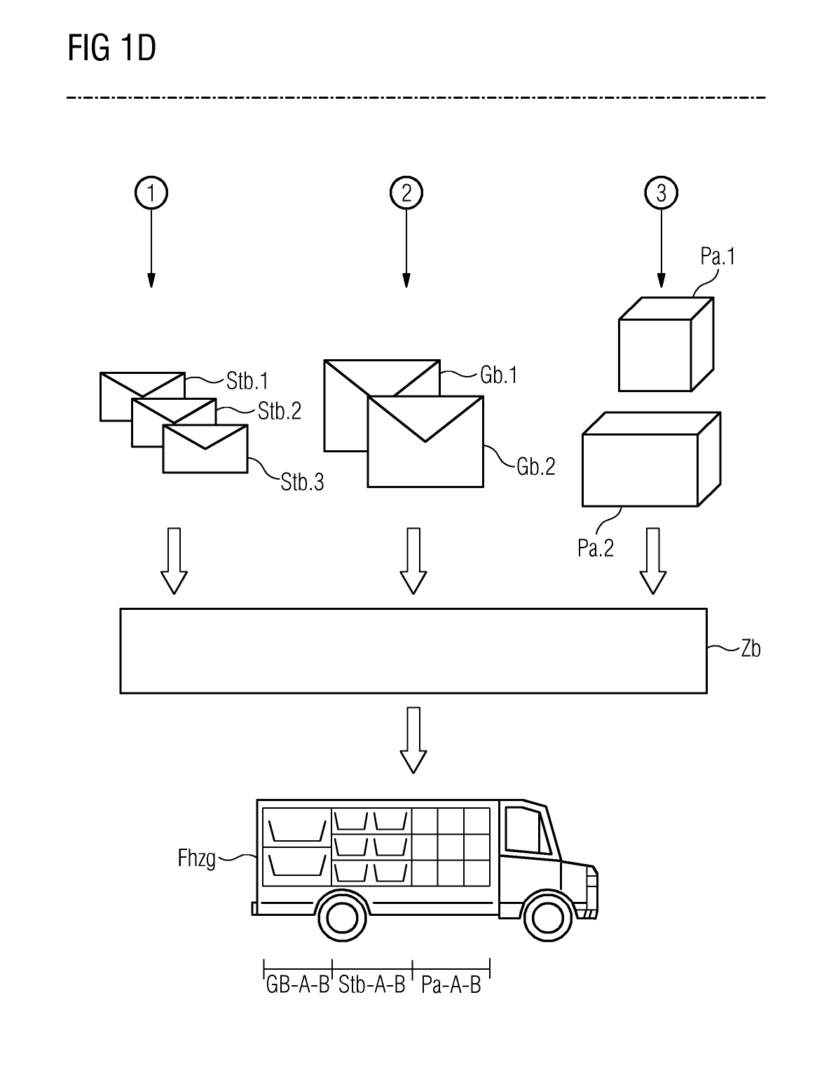

In the example,
In FIG. 1A a standard-letter sorting system Stb-SAnl sorts the standard letters,
In FIG. 1B a large-letter sorting system Gb-SAnl sorts the large letters and
In FIG. 1C a parcel-sorting system Pa-SAnl sorts the parcels.

The standard-letter sorting system Stb-SAnl of FIG. 1A comprises
a standard-letter feeder Stb-ZE, which feeds stacks of standard letters to be sorted to the sorting system Stb-SAnl,
a standard-letter singulator Stb-Ver singulates the standard letters supplied and creates a flow of spaced-apart standard letters,
a standard-letter camera Stb-Ka, which creates images of the singulated standard letters,
a transporter Stb-TE with a “delay line” for transporting standard letters,
a standard letter diverter Stb-Aus-E for distributing standard letters to the sorter exits according to the decoded destination identifications,
by way of example, five standard-letter sorter exits SAus.1.1, SAus.1.2 etc. in which in each case a stack of upright standard letters is created by the sorting and diversion,
a data memory Stb-DSp with computer-evaluable sorting-plans,
a selector unit Stb-AE, which selects a sorter exit SAus.1.1, SAus.1.2 etc. for each standard letter in dependence on the activated sorting-plan and on the delivery address determined for the standard letter and
a control unit Stb-SE.

In the example in FIG. 1B, the large-letter sorting system Gb-SAnl comprises the following components:
two parallel feeders Gb-ZE.1, Gb-ZE.2 working in parallel for feeding stacks with large letters with different formats to be sorted,
two singulators Gb-Ver.1, Gb-Ver.2 working in parallel, which singulate large letters supplied,
two cameras Gb-Ka.1, Gb-Ka.2 for large letters,
a guide Sp-FE, which transports pockets for large letters along an enclosed conveyor belt, wherein each pocket accommodates one large letter at the most,
two loading stations Bel.1, Bel.2 working in parallel, which divert large letters into pockets,
a container conveyor system Beh-FE, which transports containers on an enclosed conveyor belt and, to be precise, from the pockets for the large letters and continuously in one direction,
a drive An-Beh for the container conveyor system Beh-FE,
a feeder Zuf-Beh for feeding empty containers to the container conveyor system Beh-FE,
a removal system Weg-Beh for diverting filled containers out of the container conveyor system,
a data memory Gb-DSp with sorting-plans for the large-letter sorting system Gb-SAnl
a selector unit Gb-AE for selecting a container on the container conveyor system Beh-FE and
a control unit Gb-SE.

Therefore, the large-letter sorting system Gb-SAnl has a data memory Gb-DSp for sorting-plans, a selector unit Gb-AE for selecting sorter exits and a control unit Gb-SE. The sorter exits in the large-letter sorting system Gb-SAnl are the containers which are transported along the enclosed conveyor belt.

Each large letter is diverted by a loading station Bel.1, Bel.2 into a pocket. The pocket with the large letter is transported along the guide Sp-FE until the pocket enters a hand-over position with respect to preselected container. The large letter slides out of the pocket into this container.

In one embodiment, the large letter slides out of the pocket initially into a fixed intermediate container located above the transported container. This intermediate container in turn deposits its contents in a preselected container.

In the example in FIG. 1C, the parcel-sorting system Pa-SAnl comprises the following components:
two loading modules BM.1, BM.2 working in parallel for feeding parcels and for loading a main sorting unit Pa-FE,
two parcel singulators Pa-Ver.1, Pa-Ver.2 working in parallel,
two camera systems Pa-Ka.1, Pa-Ka.2 working in parallel,
a main sorting unit with a guide Pa-FE, which transports parcels on an enclosed conveyor belt,
three exemplary sorter exits SAus.3.1, SAus.3.2, SAus.3.3 in the form of chutes for parcels, which branch off from the guide Pa-FE,
a selector unit Pa-AE for selecting a sorter exit for a parcel
a data memory Pa-DSp with sorting-plans for the parcel-sorting system Pa-SAnl,
a selector unit Pa-AE for selecting a sorting exit for a parcel and
a control unit Pa-SE.

The area within the mail carrier's responsibility, for example a state or a region in a state, is divided into several subareas of responsibility. In each case a sorting center with at least one sorting system in each case is responsible for each subarea of responsibility.

It is possible for the division of the area of responsibility to vary from mail-item type to mail-item type and for each mail-item type and for in each case a sorting center with in each case at least one sorting system of the appropriate class to be responsible for each subarea of responsibility with respect to this mail-item type. For example, a state is divided into n1 subareas of responsibility for standard letters and large letters and in n2 subareas of responsibility for small packets and parcels. Therefore, there are n1 letter-sorting centers and n2 parcel-sorting centers. Typically, n1>n2, because there are more letters than parcels to be sorted and transported and therefore the subareas of responsibility for letters are smaller than those for parcels.

All mail items of one type which are handed over to the mail carrier in the subarea of responsibility of one sorting center are initially distributed in a dispatch-sorting process to the subareas of responsibility of the destinations. After the dispatch-sorting process, all mail items with destinations in a subarea of responsibility are transported to the sorting center for this subarea of responsibility. This sorting center carries out an incoming-sorting process for all arriving mail items.

The three sorting systems Stb-SAnl, Gb-SAnl and Pa-SAnl in FIGS. 1A, 1B and 1C in each case carry out in succession a dispatch-sorting process and then an incoming-sorting process. After the incoming-sorting process, the standard-letter sorting system Stb-SAnl and the large-letter sorting system Gb-SAnl also perform a sorting-into-order process (delivery-sequence sorting). The steps described above are performed during the dispatch-sorting process, during the incoming-sorting process and during the subsequent sorting-into-order process.

Each subarea of responsibility is divided into delivery districts, wherein each deliverer makes mail deliveries in at least one delivery district or transports them in another way to their destinations in the delivery district. As a rule, several mail deliverers deliver mail items in a delivery district to a delivery area in the delivery district in each case. In the sole sorting process during the incoming-sorting process, the mail items are divided between the delivery districts and further between the delivery areas of the deliverer.

Each delivery area in a delivery district comprises several delivery points to which mail items are to be transported. The deliverer for these delivery areas travels to the delivery points in their delivery areas in succession and delivers the mail items for these delivery points.

In the exemplary embodiment, although the subareas of responsibility can vary from mail-item type to mail-item type, the delivery districts and delivery areas are the same for all types of mail items. Hence, each delivery point belongs to one delivery area. A deliverer for this delivery area delivers all mail items for the delivery points in this delivery area, that is all standard letters, all large letters and all parcels and small packets. Therefore, this variant of the exemplary embodiment avoids the need for a letter-deliverer having to deliver the letters to a delivery point and a parcel-deliverer having to deliver the parcels and small packets to the same delivery point on the same day.

In the exemplary embodiment, the so-called logistics production cycle of the postman is one day, i.e. on each new working day, all the mail items that have arrived up to this working day and have not yet been delivered are delivered once again. According to the invention, there is no need for the step in which different deliverers drive to the same delivery point on the same day. This would require a longer overall travel distance for the means of transportation used and therefore incur higher traveling costs. The delivery districts and delivery areas are organized such that a deliverer is able to deliver all mail items of all types to the destinations in this delivery district without infringing statutory or operational requirements with respect to working time.

As already explained, during the sole sorting process of the incoming-sorting process, the incoming mail items are divided between the delivery districts and further into the delivery areas. Since no universal sorting system is used in the exemplary embodiment, this division is also performed individually for each mail-item type so that in each case a quantity of mail items of this mail-item type is created for each delivery area and each mail-item type.

During the dispatch-sorting process and also during the sole sorting process during the incoming-sorting process, the respective delivery address of each mail item is determined, as a result of which the destination to which this mail item is to be transported is also determined. For example, an identification of the destination address on the mail item is read by OCR. Or a sorting code for this destination is decoded wherein this sorting code has been applied to the mail item in a preceding processing step. Or a unique identification on the mail item is decoded and a data record for the mail item with this identification and with an encoded delivery address is determined in a database. This data record was created in a preceding processing step.

Hence, following the sole sorting process in the incoming-sorting process, it is known for each destination of the subarea of responsibility how many mail items of which mail-item type are to be transported to this destination. In particular, it is known for each delivery area in the subarea of responsibility to which destinations in this delivery area any mail items are to be transported on this day and to which destination no mail items, that is neither letters nor parcels, are to be transported.

In one embodiment, after the incoming-sorting process, a delivery sequence (“carrier walk sequence”) of the actual destinations is specified, i.e. in each case an order of the destinations in each delivery area. A computer-accessible specification of this delivery sequence is created and stored. To generate this delivery sequence, a computer-accessible map with the possible destinations and the available traffic routes in the delivery area is specified and a route optimization creates a delivery sequence, which is, for example, optimized in accordance with a specified criterion. Therefore, this delivery sequence can therefore change from day to day.

In another embodiment, the delivery sequence is specified in advance and does not change from day to day, but remains constant.

In one embodiment, following an incoming-sorting process, the standard letters and large letters are sorted in the subsequent sorting-into-order process according to the delivery sequences of the delivery areas while the parcels are only divided into delivery areas.

Therefore, in the exemplary embodiment, each sorting system Stb-SAnl, Gb-SAnl, Pa-SAnl counts during the dispatch-sorting process or the incoming-sorting process how many mail items of a mail-item type are in each case to be transported to which destination in a delivery area. As mentioned above, the mail items of one mail-item type are sorted by a specialized sorting system. While the specialized sorting system performs the dispatch-sorting process or the incoming-sorting process, in each case a list is created for each mail-item type. For example, a first list is created for the standard letters, a second list for the large letters and a third list for the parcels and small packets. These lists are sent to a central data-processing system. This central data-processing system creates a single list containing for each destination in the delivery area and for each mail-item type the number of mail items of this mail-item type to this destination. This step is repeated anew for each working day.

In the exemplary embodiment, in a sorting-into-order process after the incoming-sorting process, a quantity of all flat mail items, for example all flat mail items for a delivery area are placed in order according to their delivery addresses (“delivery point sequencing”). This order is specified by the generated or specified delivery sequence. A first sorting system for standard letters, namely the standard-letter sorting system Stb-SAnl in FIG. 1A places all standard letters (including postcards) in an order of this kind. A second sorting system for large letters, namely the large-letter sorting system Gb-SAnl in FIG. 1B, also places all large letters (including journals and catalogs) in an order of this kind. Here, the standard letters are not mixed with the large letters. The standard-letter sorting system Stb-SAnl is not able to sort any large letters. The large-letter sorting system Gb-SAnl would achieve too low a throughput when sorting standard letters. Since each of these sorting systems Stb-SAnl, Gb-SAnl has fewer sorter exits than there are different destinations, after the incoming-sorting process the sorting system performs several sorting passes after the sorting-into-order (“n-pass sequencing”) in order to place the standard letters or large letters in the desired order. Preferably, two successive sorting passes are performed in the sorting-into-order (“2-pass sequencing”).

In the exemplary embodiment, the parcels are not automatically sorted according to the delivery sequence. Therefore, for parcels, on each working day, a dispatch-sorting process and an incoming-sorting process in each case with a sorting pass are performed but no sorting-into-order process.

FIG. 1D is a schematic diagram of a logistics network with the three sorting systems Stb-SAnl, Gb-SAnl, Pa-Sanl, a distribution center Zb and a delivery vehicle Fhzg. The sorting system Stb-SAnl sorts standard letters precisely according to delivery sequence and has sorter exits Aus.1.1, Aus.1.2, etc. in FIG. 1A in the form of stacking compartments. The sorting system Gb-SAnl sorts large letters precisely according to delivery sequence and has sorter exits Aus.2.1, Aus.2.2, etc. in FIG. 1B in the form of containers, which are transported by the container conveyor system Beh-FE along an enclosed conveyor belt. The sorting system Pa-SAnl has sorter exits Aus.3.1, Aus.3.2, etc. in FIG. 1C in the form of chutes and sorts parcels.

The standard letters sorted precisely according to delivery sequence, including the three exemplary standard letters Stb.l, Stb.2, Stb.3, are transported from the standard-letter sorting system Stb-SAnl in a truck Lkw.l (FIG. 1A) to the distribution center Zb, (FIG. 1D) i.e. separate from the standard letters. The large letters sorted precisely according to delivery sequence including the two exemplary large letters Gb.1, Gb.2, are also transported in a truck Lkw.2 (FIG. 1B) to the distribution center Zb, i.e. separate from the standard letters and large letters. The parcels, including the two exemplary parcels Pa.l, Pa.2, are also transported in a further truck Lkw.3 (FIG. 1C) to the distribution center Zb. The standard letters from the truck Lkw.l, the large letters from the truck Lkw.2 and the parcels from the truck Lkw.3 are brought to the distribution center Zb in the delivery vehicle Fhzg (FIG. 1D) or distributed between several delivery vehicles. This delivery vehicle Fhzg functions as the means of transportation.

It is possible for a first truck to arrive at the distribution center Zb earlier than a further truck and for the mail items from this first truck to be stored temporarily in the distribution center Zb or placed in a delivery vehicle Fhzg.

The deliverer for a delivery area travels with a means of transportation, for example with the delivery vehicle Fhzg, to the destinations in this delivery area and, to be precise in the order of the destinations specified by the delivery sequence, wherein this delivery sequence is specified in advance or calculated anew each day by a route planning system. In the delivery vehicle Fhzg, at least three accommodation areas are identified namely in each case an accommodation area for standard letters, an area for large letters and an area for parcels and small packets.

The sorted standard letters are placed by the standard-letter sorting system Stb-SAnl in containers. These containers filled with standard letters are placed on the marked accommodation area for standard letters in the delivery vehicle Fhzg. It is possible for the delivery sequence be divided into sections and for each container exclusively to contain sorted mail items for a section of this delivery sequence. The standard-letter sorting system Stb-SAnl prints a previously empty label (“tray label”) with an identification of the section in a form readable by humans and inserts the printed label in a holder on the container. This step is performed while the container stands on a storage space of the respective sorter exit.

The standard letters preferably stand upright in a container, so that a deliverer can “finger through” them. This rack—or a part of this rack—functions as an accommodation area for standard letters.

In one embodiment, the storage space of the delivery vehicle Fhzg has a rack for containers with standard letters. The standard letter containers are preferably placed in the rack such that the respective label with the identification of the section is visible from outside and the order of the containers corresponds to the sequence of the sections.

The large-letter sorting system Gb-SAnl also diverts the sorted large letters into in containers, wherein the large letters lie in the container. Namely, the dimensions (length, thickness, height) of the large letters vary much more greatly than the dimensions of the standard letters. Each large letter container also bears a label in a holder (“tray label”) showing the section of the delivery sequence to which the destinations of the large letters in this container belong. The containers are placed in the same or another rack in the delivery vehicle Fhzg in each case in or on a section specially marked for large letters.

It is also possible for a single racking face in the delivery vehicle Fhzg to have both places for large letter containers and places for standard letter containers. This one racking face then has an accommodation area for standard letters and a further accommodation area for large letters. The large letter containers differ in their appearance, for example due to larger dimensions or different labels or a different color, from the standard letter containers.

FIG. 1D shows a schematic view of a racking face with an accommodation area Gb-A-B for large letters (on the left) and an accommodation area Stb-A-B for standard letters (in the middle). In each case, several containers are indicated in these accommodation areas Gb-A-B and Stb-A-B.

Each parcel and each small packet is also placed on a position in a racking face in the delivery vehicle Fhzg. Preferably, a loading list is created containing the delivery address (or at least its destination) and the position in the delivery vehicle Fhzg of each parcel. This loading list is sorted according to destinations so that the deliverer can see where in the delivery vehicle Fhzg the parcels for a specific destination are located. A method of this kind is, for example, described in DE 10 2009 024 195 A1. The loading list does away with the need to have to place a parcel in the racking face with the address side facing the deliverer or to have to turn different parcels around in order to read the address when searching for parcels to a delivery point.

It is also possible for each position for a parcel or a small packet to be provided with a pilot light. As soon as the delivery vehicle Fhzg is located in the vicinity of a destination, the pilot light in each position on which a parcel for this destination is located lights up. In one embodiment, a sensor registers that a parcel has been removed from the position. This signal from the sensor triggers the step in which the pilot light is switched off again.

FIG. 1D also shows an accommodation area Pa-A-B for parcels, namely on the right in the racking face.

During the delivery journey, deliverers carry a data-processing device with them, which assists the deliverer with the delivery. This data-processing device is for example a mobile device (cell phone, smartphone, PDA or the like) or is permanently installed in the delivery vehicle, for example as an extension to a standard satnav system.

Preferably, the data-processing device can be inserted in a slot in the delivery vehicle Fhzg or coupled to the delivery vehicle Fhzg in some other way in order in this way to be connected to the electricity supply. The data-processing device Mob can be uncoupled again from the delivery vehicle Fhzg in order to be provided with new data in a fixed “docking station”.

The data-processing device is able to output information in a human-ascertainable form, for example on a screen device or by voice output. For example, the data-processing device has a screen device and buttons or keys so that a user is able to control and parametrize the output on the screen device. In one embodiment, the device also has a module for voice output so that the voice output supports the output on the screen device. It is also possible for the device to output information to a human exclusively by voice output.

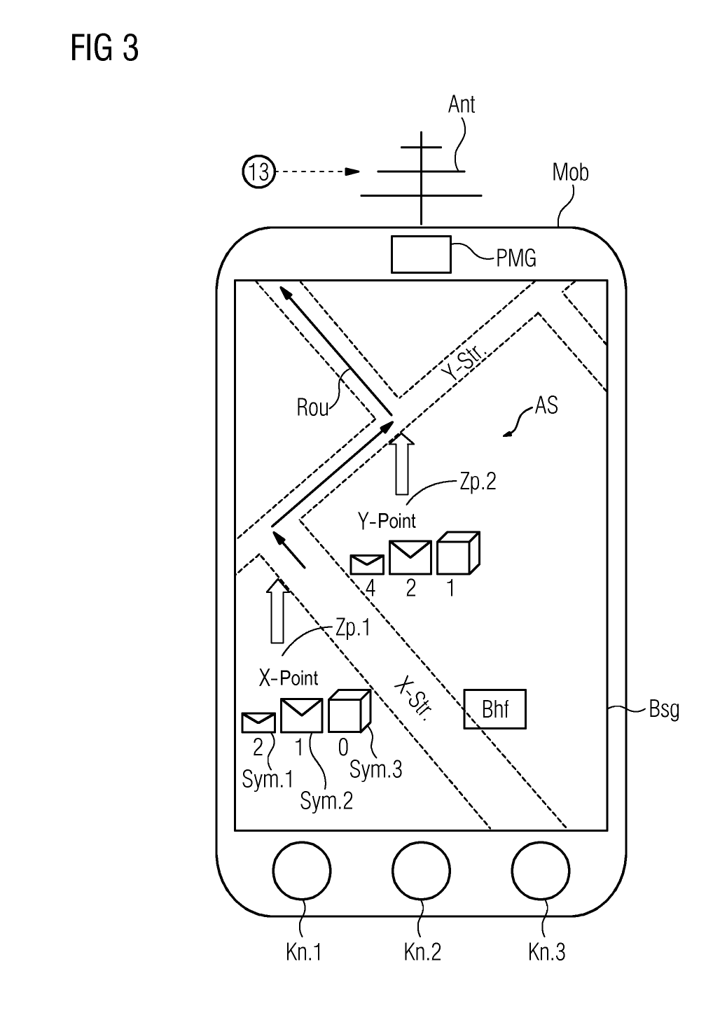

FIG. 3 to FIG. 6 show by way of example a mobile data-processing device Mob with
a screen device Bsg,
a number of buttons Kn.l, Kn.2, etc.
in one embodiment, a speaker or the like for voice output,
a position measuring device PMG,
an antenna Ant,
a local data memory,
a local processor (CPU) and
in one embodiment, with a local power supply.

The following information is sent to this data-processing device Mob:
which destinations in which order which the mail deliverer has to find in order to deliver mail items, i.e. a description of the calculated or specified delivery sequence,
for each destination and each mail-item type, the number of mail items of this mail-item type, which are to be transported to this destination, or at least, for each mail-item type, the information as to whether at least one mail item of this type is to be transported to this destination or not,
in one embodiment, the next section of route to the destinations to be travelled,
in one embodiment, the loading list for the parcels in a computer-accessible form and
in one embodiment, a computer-accessible loading list for the standard letter containers and the large letter containers.

This information is stored in the local data memory of the data-processing device Mob. This information was previously automatically generated by a fixed data-processing system DVA automatically belonging to a sorting center, for example. The information is sent to the device Mob either via an air interface, for example by means of a mobile radio standard, or via a physical coupling point. The physical coupling point belongs for example to a base station or “docking station” for the mobile data-processing device Mob. In the example in FIG. 3 to FIG. 6, the central data-processing system DVA sends the information to the device Mob via an air interface using an antenna Ant-DVA.

In the exemplary embodiment, the following information is sent to the central data-processing system DVA:
From the standard-letter sorting system Stb-SAnl: How many standard letters are to be sent to which destination in the specified area in each case?
From the large-letter sorting system Gb-SAnl: How many large letters are to be sent to which destination in the specified area in each case?
From the parcel-sorting system Pa-SAnl: How many parcels are to be sent to which destination in the specified area in each case?

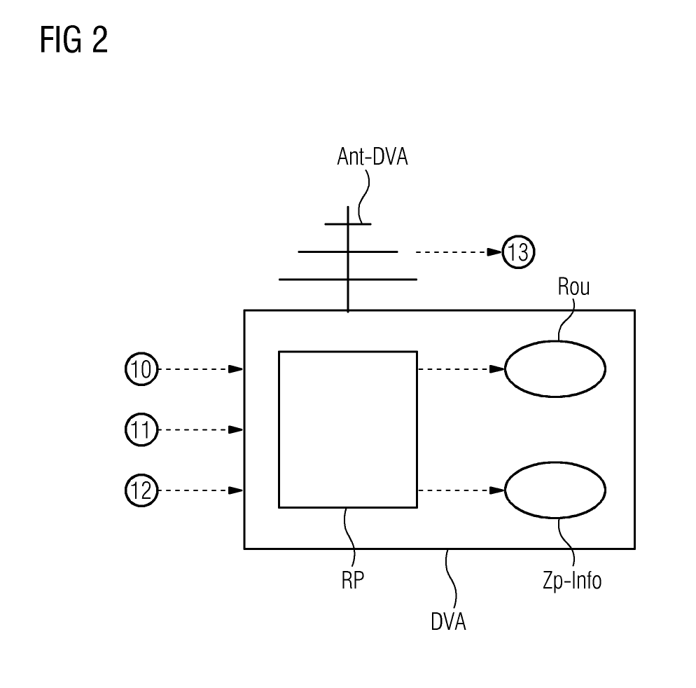

FIG. 2 shows the central data-processing system DVA, which receives the measured numbers for each destination from the three sorting systems Stb-SAnl, Stb-SAnl and Pa-SAnl. The central data-processing system DVA calculates the destination-information Zp-Info to be sent to the mobile device Mob. The central data-processing system DVA sends the destination-information Zp-Info to the mobile data-processing device Mob with the aid of an antenna Ant-DVA of the central data-processing system DVA via the air interface.

In one embodiment, a route planner in the central data-processing system DVA automatically calculates a route anew for each day. This route relates to all destinations to which at least one mail item is actually to be delivered on this day. For the route planning, the route planner determines for each destination the measured number of standard letters, large letters and parcels to this destination. In this way, the route planner automatically determines to which destinations any mail items are to be delivered on this day. The route planner calculates a route, wherein the route planner preferably uses an optimization method and a computer-evaluable description of the route network and the travel times in the specified area.

In one embodiment, a minimum number is specified, for example two or three. The route is automatically calculated such that the route relates to a destination in each case when at least as many mail items as the minimum number are currently to be delivered to this destination, i.e. for example at least two mail items or at least three mail items. The route does not relate at all to a destination with fewer mail items unless this destination can be reached without deviation. In a development of this embodiment, in each case a minimum number is specified for each mail-item type, for example one for parcels and two for standard letters and large letters. If, at least one parcel or overall at least two flat mail items (standard letters and/or large letters) are to be delivered to a destination, the calculated route relates to this destination. This enables shorter routes to be calculated and the costs of the delivery are reduced.

FIG. 2 shows also shows the route planner RP, which calculates a route Rou to the destinations that actually exist. This calculated route Rou is sent to the device Mob via the air interface with the aid of the antennas Ant-DVA and Ant.

A computer-evaluable map is also stored in this local data memory of the device Mob. The map covers the deliverer's delivery area and hence each calculated route in this delivery area. In FIG. 3, a section AS from this map is displayed on the screen device Bsg. For example a position measuring device PMG of the device Mob or of the delivery vehicle Fhzg with the device Mob measures where the delivery vehicle Fhzg is currently located. A section AS of the map containing the current location of the delivery vehicle Fhzg is shown. This section AS also contains several destinations to which in each case at least one mail item in the delivery vehicle Fhzg is to be transported. The destinations are shown in the map depiction on the screen device Bsg.

For example, an alphanumerical description of the respective mailing address of each destination is depicted in the section displayed on the screen device Bsg. The address description matches an address identification on the actual mail item. If the destination of a mail item is identified by geographical coordinates, an alphanumerical description of these geographical coordinates is displayed.

The example in FIG. 3 to FIG. 6 shows a section AS with the X street and the Y street and with the two delivery points Zp.l, Zp.2.

The section AS shown preferably also includes a section of the specified route Rou along the destinations Zp.l, Zp.2 depicted, wherein this section is specified by the delivery sequence sent and stored locally or by the route Rou sent and is a section of the delivery sequence. The example in FIG. 3 to FIG. 6 shows the next section of the route Rou, which starts at the current destination Zp.l.

It is also possible for the mail deliverer to be supported by a voice output in driving to the destinations Zp.l, Zp.2 according to the delivery sequence, for example as is familiar from a satnav system in a motor vehicle. In this embodiment, the actual data-processing device Mob has a speaker or controls a speaker in the delivery vehicle Fhzg an.

In one embodiment, a pictorial symbol (“pictogram”, “icon”) is assigned to each object type, i.e. here each mail-item type, for example a first pictogram for standard-letters, a second pictogram for large letters and a third pictogram for parcels. The pictograms differ in their colors and/or shapes from each other and from symbols for geographical objects in the section AS of the stored map shown. Each pictogram is also stored in the local data memory, namely in that an encoding of this pictogram is stored.

In the example in FIG. 3 to FIG. 6 the standard letters are assigned the symbol Sym.l in the form of a small letter, the large letters are assigned the symbol Sym.2 in the form of a large letter and the parcels are assigned the symbol Sym.3 in the form of a rectangular parcel.

As already explained, the data-processing device Mob displays a section AS of the delivery area on the screen device Bsg, wherein the device Mob uses a computer-evaluable map stored in the local data memory. In this depiction, the destinations are identified that lie the in the depicted section and to which in each case at least one mail item is to be transported. In addition, the next section of the route Rou is shown.

The following information is shown for each destination Zp.1, Zp.2 of a shown section AS:
an alphanumerical description of the mailing address or the geographical coordinates of this destination Zp.l, Zp.2,
for each mail-item type, at least the pictogram Sym.l, Sym.2, Sym.3 for this mail-item type if at least one mail item located in the delivery vehicle Fhzg is to be delivered to this destination and
in one embodiment, in the pictogram Sym.l, Sym.2, Sym.3 or next to or under or over the pictogram Sym.l, Sym.2, Sym.3 for a mail-item type, the number of mail items of this mail-item type for this destination Zp.l, Zp.2.

One embodiment envisages that a pictogram Sym.l, Sym.2, Sym.3 for one mail-item type is also shown in connection with a destination Zp.1, Zp.2 if no mail item of this mail-item type is to be transported to this destination.

In the example in FIG. 3 to FIG. 6, a section AS including the X street and the Y street with a rail station Bhf and two destinations Zp.1, Zp.2 is shown on the screen device Bsg. This shows that two standard letters (symbol Sym.l and the number 2), one large letter (symbol Sym.2 and the number 1) and no parcels (symbol Sym.3 and the number 0) from the delivery vehicle Fhzg are to be delivered to the destination Zp.1 (X-point on the X street). Four standard letters, two large letters and a parcel are to be delivered to the destination Zp.2 (Y-point on the Y street).

In one embodiment, the mobile device Mob is able to display different types of detailed information on mail items for a delivery point on the screen device Bsg. In a standard mode, in the vicinity of destination-depictions, only the symbols (pictograms) for those mail item types to which the mail items to this destination belong are shown on the screen device Bsg, and to be precise without the respective number. In the standard mode, information on several destinations can be depicted simultaneously on the screen device Bsg.

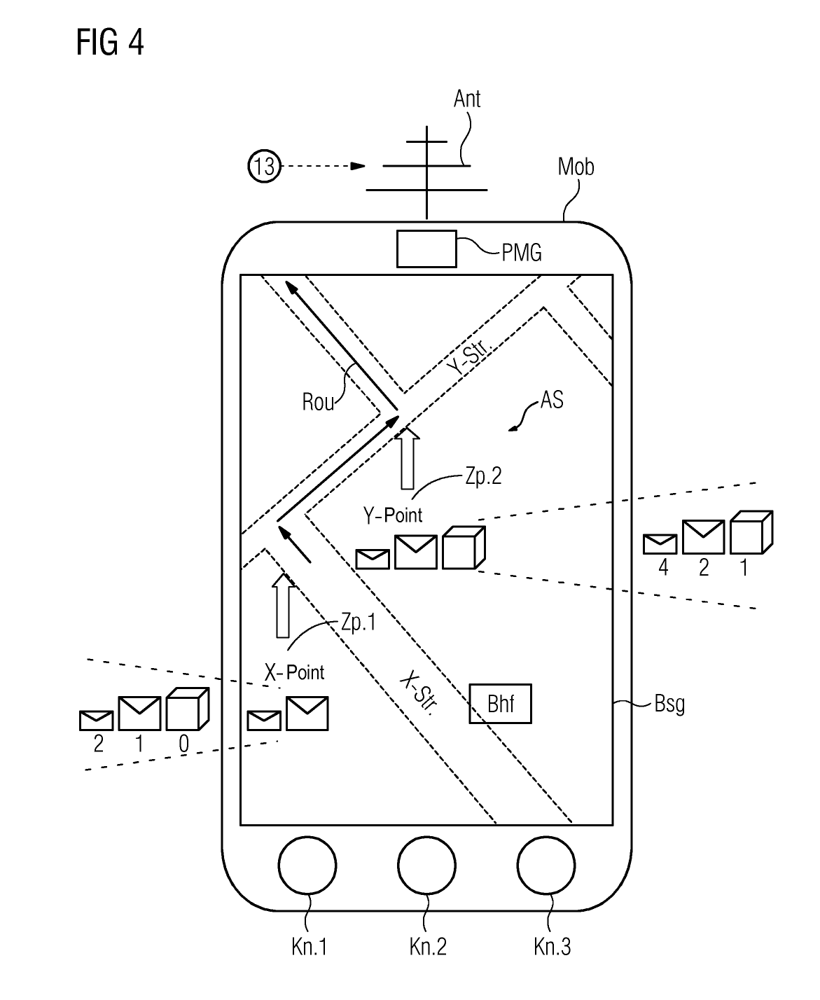

Following a corresponding user input, the mobile device Mob changes to a detail-mode with respect to a destination and shows the desired number of mail items of each mail-item type for this destination as depicted in FIG. 4. For example, the screen device Bsg is touch-sensitive (in the form of a touchscreen). A user input in the form of touching the screen device Bsg in the vicinity of the depiction of a destination causes the mobile device Mob to change from the standard mode into the detail-mode with respect to this destination.

In FIG. 4, it is shown in the standard mode that at least one standard letter and at least one large letter is to be delivered to the destination X-point and all three mail item types are to be delivered to the destination Y-point. The dashed lines expanding in a funnel shape indicate the transition from the standard mode in the detail-mode for both destinations ZP.l, ZP.2. Shown on the right, next to the device Mob, are the respective numbers of standard letters, large letters and parcels.

In one embodiment, the mobile device Mob also outputs the information as to how many mail items of which mail-item type are to be delivered to which areas of a destination in each case, wherein all areas of the destination have the same mail address. The common mail address designates several individual areas of a destination, for example several floors of a high-rise building or several households in an apartment building. All addressees at this destination have the same mail address. On the screen device, the information on the mail items to a destination are divided into several display areas, preferably in a display area for each area of the destination. For example, the information on mail items to addresses on the ground floor of a high-rise building is shown in the lowest line, namely in each case a symbol for a mail-item type and its number. The line above shows the information on mail items for addresses on the first floor etc. In an apartment building, a display area is shown for each household in this apartment building.

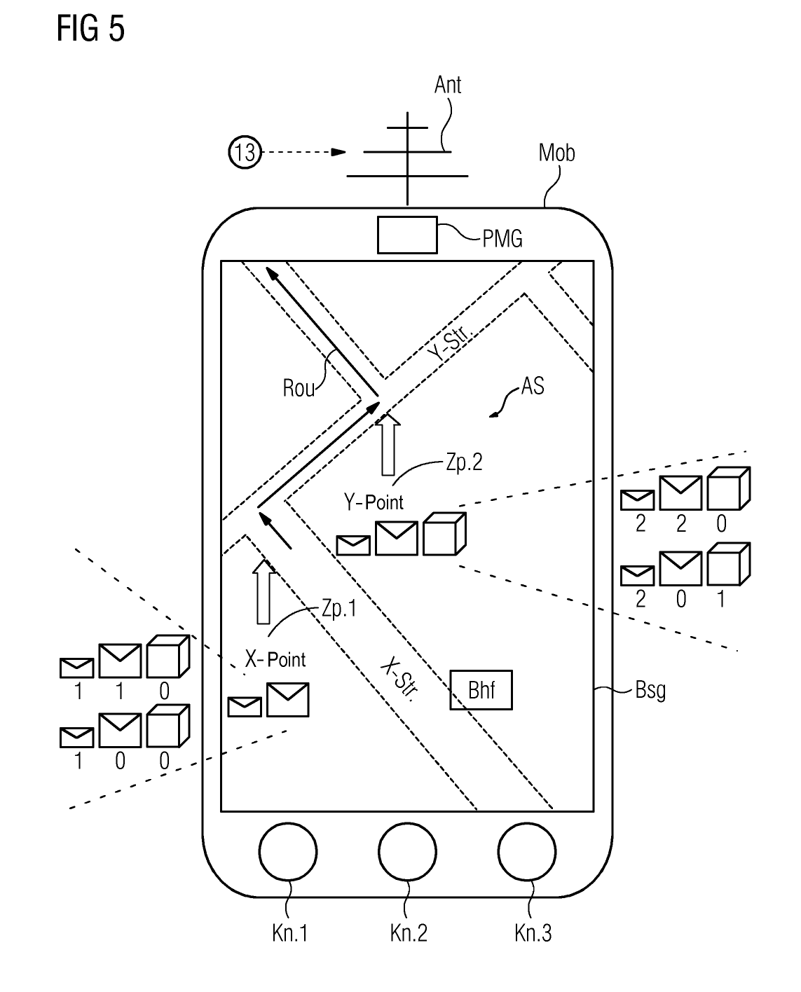

The example in FIG. 5 shows by way of example two destinations, X-point and Y-point with in each case two different addressees with the same mail address X-point or Y-point. In FIG. 5, the device Mob again shows in the standard mode which mail item types are to be delivered to the two destinations X-point and Y-point in each case. In both in the destination X-point and the destination Y-point, mail items are to be distributed to two different areas in each case, for example to two floors of an apartment building. Only a standard letter to be delivered in the lower area of X-point and a standard letter and a large letter are to be delivered in the upper area. In the lower area of the destination Y-point, two standard letters, no large letter and a parcel are to be delivered, in the upper area two standard letters, two large letters and no parcel. This information is shown on the screen device Bsg in the detail-mode (dashed lines).

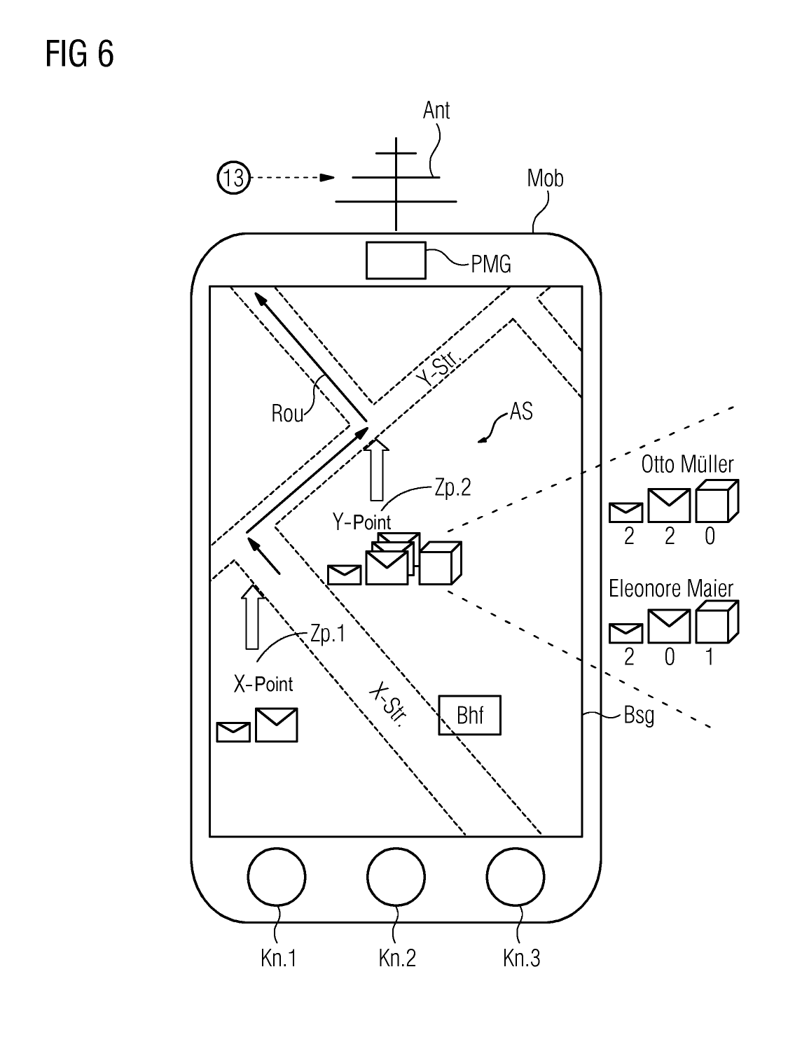

FIG. 6 is a more detailed depiction of the information on mail items to be delivered. For each area of the destination Y-point, the name of the respective recipient is additionally shown. Otto Müller lives on the upper floor and Eleonore Maier lives on the lower floor. Even in the standard mode, in the embodiment in FIG. 6, a number of symbols one after the other in the style of a stack indicates that the destination Y-point includes several areas.

As soon as the mail deliverer reaches a depicted destination Zp.l, Zp.2, he determines from the depiction on the screen device Bsg the information as to which mail-item type or which mail item types the mail items for this destination Zp.l, Zp.2 are and, in one embodiment, the respective number for each mail-item type. The mail deliverer removes from the respective accommodation area in the delivery vehicle Fhzg all mail items of a mail-item type for this destination Zp.l, Zp.2. For example, the mail deliverer removes from a standard letter container all standard letters for the destination Zp.l, Zp.2, from a large letter container all large letters for this destination Zp.l, Zp.2 and from the parcel racking face all parcels and small packets for this destination Zp.l, Zp.2. At the same time, the mail deliverer looks in the respective accommodation area of the delivery vehicle Fhzg for the number of mail items specified to him by the information output.

The standard letters for a destination are generally located in one single container and are arranged in the stacks of standard letters in this container in a direct series one behind the other. This is the result of the sorting-into-order performed by the standard-letter sorting system Stb-SAnl. The same applies to the large letters.

When necessary, the mail deliverer consults the respective loading list in order to find the respective position for the container or the parcel in the delivery vehicle Fhzg. This loading list is provided in paper-based form or is shown on the screen device Bsg of the data-processing device Mob. Preferably, a section from the loading list including the mail items for the next destination ZP.l, ZP.2 is shown on the screen device Bsg. It is also possible for the mail deliverer to use one single loading list that applies to all mail item types.

In one embodiment, in each case an encoding for a term identifying this mail-item type, for example “letter”, “large letter” and “parcel” or “letter”, “flat” and “parcel” is stored in the local data memory of the device Mob for each mail-item type. As soon as the delivery vehicle Fhzg, has reached a destination Zp.1, Zp.2, the data-processing device Mob outputs by voice processing and voice output the terms for those mail item types, for which at least one mail item is to be transported to this destination. To this end, the voice processing unit processes the stored terms for mail item types. In one embodiment, the number is also output by voice output, wherein the stored terms for mail item types and stored words for numbers are used. Therefore, the voice output sounds, for example, as follows

“letter 3 parcel 1”
or
“letter 3 large letter 0 parcel 1”.

This voice output can supplement or even replace the pictorial output on the screen device Bsg.

In one embodiment, the voice processing for a destination is already performed while the mail deliverer is still driving the delivery vehicle to this destination and the terms and numbers are also output during this journey. In another embodiment, the voice output is performed when the mail deliverer and delivery vehicle Fhzg have already reached the next destination.

The mail deliverer removes at a destination Zp.1, Zp.2 all mail items for this destination from the means of transportation (here: the delivery vehicle Fhzg) and delivers the mail items, or at least attempts to deliver them. The mail deliverer posts a standard letter and a large letter into a mailbox or places them in a mail compartment. The mail deliverer hands a parcel or small packet to an authorized recipient or places it in a parcel compartment of a parcel box system. It is possible that the mail deliverer will not encounter an authorized recipient or that the recipient will refuse acceptance. In one embodiment, the mail deliverer leaves a notification of the failed attempt to make a delivery to the recipient's mailbox. In this case, the mail deliverer returns the parcel/small packet back to the delivery vehicle Fhzg.

When the mail deliverer has completed the delivery of all mail items to a destination Zp.1, Zp.2—or has identified that the delivery of individual mail items is not possible at present—in one embodiment, the deliverer presses a button Kn.l, Kn.2, etc. on the data-processing device Mob. By pressing this button or another action or input, the deliverer confirms that the delivery of mail items to this destination has been completed for this logistics production cycle.

In one embodiment, the confirmation triggers the step in which the data-processing device Mob depicts another section on the screen device Bsg. This other section preferably no longer shows the information on the “old” destination, for which the delivery has been completed, but, instead of this, shows information on an additional new destination. This embodiment avoids unnecessary information being depicted, namely information on the old destination.

In the example in FIG. 3 to FIG. 6, the input triggers the step in which a changed section is shown on the screen device Bsg, which instead of the “old” destination Zp.1 shows a “new” destination Zp.3, wherein this destination Zp.3 comes after the destination Zp.2 on the delivery route.

### LIST OF REFERENCE CHARACTERS

| | |
|---|---|
| An-Beh | Drive for the container conveyor system Beh-FE |
| An-Sp | Drive for the pockets in the pocket guide Sp-FE |
| Ant | Antenna of the mobile data-processing device Mob |
| Ant-DVA | Antenna connected to the central data-processing |
| | system DVA |
| AS | Section of the computer-accessible map currently |
| | shown on the screen device Bsg |
| Ba-A-B | Accommodation area for parcels in the delivery |
| | vehicle Fhzg |
| Beh-FE | Container conveyor system for the large-letter |
| | sorting system Gb-SAnl |
| B.1, BM.2 | Loading modules in the parcel-sorting system Pa- |
| | SAnl |
| Bsg | Screen device in the mobile data-processing |
| | device Mob |
| DVA | Central data-processing system |
| Fhzg | Delivery vehicle in the distribution center Zb, |
| | functions as a means of transportation |
| Gb-A-B | Accommodation area in the delivery vehicle Fhzg for |
| | containers with large letters |
| Gb.l, Gb.2 | Large letters |
| Gb-AE | Selector unit for the large letter-sorting system Gb- |
| | SAnl |
| Gb-Ka.l, | Cameras for the large letter-sorting system Gb-SAnl |
| Gb-Ka.2 | |
| Gb-SAnl | Large letter-sorting system |
| Gb-SE | Control unit for the large letter-sorting system Gb- |
| | SAnl |
| Gb-Ver.l, | Singulators for the large letter-sorting system Gb- |
| Gb-Ver.2 | SAnl |
| Gb-ZE.l, | Feeders for the large letter-sorting system Gb-SAnl |
| Gb-ZE.2 | |
| Kn. 1, Kn.2, | Buttons for the device Mob |
| etc. | |
| Lkw.1 | Truck, transports standard letters from the standard- |
| | letter sorting system Stb-SAnl to the distribution |
| | center Zb |
| Lkw.2 | Truck, transports large letters from the large letter- |
| | sorting system Gb-SAnl to the distribution center Zb |
| Lkw.3 | Truck, transports parcels from the parcel-sorting |
| | system Pa-SAnl to the distribution center Zb |
| Mob | Mobile data-processing device with the screen device |
| | Bsg |
| n1 | Number of subareas of responsibility for letters |
| n2 | Number of subareas of responsibility for parcels |
| Pa.l, Pa.2 | Parcels |
| Pa-AE | Selector unit for the parcel-sorting system Pa-SAnl |
| Pa-FE | Parcel conveyor system for the parcel-sorting system |
| | Pa-SAnl |
| Pa-Ka.l, | Cameras for the parcel-sorting system Pa-SAnl |
| Pa-Ka.2 | |
| Pa-SAnl | Parcel-sorting system |
| Pa-SE | Control unit for the parcel-sorting system Pa-SAnl |
| Pa-Ver.l, | Parcel singulators in the parcel-sorting system Pa- |
| Pa-Ver.2 | SAnl |
| PMG | Position measuring device for the mobile device Mob |
| Rou | Calculated route to the next destinations |
| RP | Route planner, calculates the route Rou |
| SAus.1.1, | Sorter exits for the standard-letter sorting system |
| SAus.1.2, | Stb-SAnl |
| etc. | |
| SAus.2.1, | Sorter exits for the large letter-sorting system Gb- |
| SAus.2.2, | SAnl |
| etc. | |
| SAus.3.1, | Sorter exits for the parcel-sorting system Pa-SAnl |
| SAus.3.2, | |
| etc. | |
| Stb.l, Stb.2 | Standard letters |
| Stb-A-B | Accommodation area in the delivery vehicle Fhzg for |
| | containers with standard letters |
| Stb-AE | Selector unit for the standard-letter sorting system |
| | Stb-SAnl, selects a sorter exit SAus. 1.1, SAus. 1.2, |
| | etc. the standard-letter sorting system Stb-SAnl |
| | according to the activated sorting-plan |
| Stb-Aus-E | Diverter for the standard-letter sorting system Stb- |
| | SAnl |
| Stb-DSp | Data memory for the standard-letter sorting system |
| | Stb-SAnl, contains the sorting-plans for the standard- |
| | letter sorting system Stb-SAnl |
| Stb-Ka | Camera for the standard-letter sorting system Stb-SAnl |
| Stb-SAnl | Standard-letter sorting system |
| Stb-SE | Control unit for the standard-letter sorting system |
| Stb-TE | Transporter with “delay line” for the standard-letter |
| | sorting system Stb-SAnl |
| Stb-ZE | Feeder for the standard-letter sorting system Stb-SAnl |
| Stb-Ver | Singulator for the standard-letter sorting system Stb- |
| | SAnl |
| Sym.l | Symbol for standard letters |
| Sym. 2 | Symbol for large letters |
| Sym. 3 | Symbol for parcels |
| Weg-Beh | Removal system for filled containers |
| Zb | Distribution center with the delivery vehicle Fhzg |
| Zp-Info | Destination-information: How many mail items of which |
| | mail-item type are to be delivered to destination in |
| | each case? |
| Zp.l, Zp.2 | Destinations X-point, Y-point shown on the screen |
| | device Bsg |
| Zuf-Beh | Feeder for empty containers |

1. A method for transporting a plurality of objects to a plurality of specified destinations, wherein
at least two types of objects are specified, and each object to be transported belongs to at least one of a specified object type;
a transportation device configured and operable for the transportation of the objects, the transportation device has at least one accommodation area for each object type to accommodate objects of the respective object type to be transported at the respective accommodation area;
the method comprises the following steps:
determining the destination to which each object is to be transported;
placing all objects to be transported in or on the transportation device such that each object is in or on the respective accommodation area or areas for this object type;
transporting the transportation device to the determined destinations of the objects to be transported in succession;
at each destination, removing the respective objects for this destination from the transportation device;
during the transportation to the destinations of the objects to be transported, providing a data-processing device which receives the following information and sends the information to the data-processing device:
the destinations to which in each case at least one object is to be transported; and
for each destination and for each object type, the information is as to whether no or at least one object of this object type is to be transported to this destination; and
during the transportation, causing the data-processing device to output for each destination to which the transportation device travels, in a human-ascertainable form, the information as to which object type or types in or on the transportation device are to be transported to this destination.

2. The method as claimed in claim 1, wherein
the data-processing device comprises a screen device, and the method further comprises:
displaying on the screen device a graphical symbol for each object type in each case and during the information output for a destination;
displaying an identification of the destination; and
for each object type, of which type an object is to be transported to the destination displaying the symbol for this object type on the screen device in a human-ascertainable form.

3. The method as claimed in claim 2, further comprising during the information output for a destination supplied by the data processing device, causing the data-processing device to display on the screen device:
a section from a computer-accessible map, wherein the section shown indicates an identification of the destination; and
depicting an assignment of each object type-symbol to this destination-depiction.

4. A method as claimed in claim 1, further comprising causing the data processing device to specify a term for an object for each object type and in each case specifying the term and to output the information output for a destination for the object, wherein the data-processing device is caused to output for each object type to which at least one object belongs and which is to be transported to the destination, and is caused to specify a term for this object type in a human-ascertainable form in a voice output.

5. A method as claimed in claim 1, further comprising:
for each destination and each object type, automatically counting how many objects of this object type are to be transported to this destination; and
during the transportation, causing the data-processing device to output for each destination and for each object type in a human-ascertainable form the information as to how many objects of this object type are to be transported to this destination.

6. A method as claimed in claim 1, further comprising:
for each destination and each object type, making an automatic count of how many objects of the object type are to be transported to the destination;
automatically calculating, dependent on the measured numbers of objects being transported, a route including at least some of the destinations of the objects;
sending the calculated route to the data-processing device; and
causing the data-processing device to output information on the calculated route in a human-ascertainable form.

7. The method as claimed in claim 6, further comprising, for each object type, specifying a count of a minimum number and calculating the route to include a destination, for at least one object type when the counted number of objects of this object type to this destination is greater than or equal to the specified minimum number for this object type.

8. An arrangement for transporting a number of objects to respective destinations, wherein there are at least two types of the objects to be transported and each object to be transported is of a specified object type;
the arrangement comprising:
a central data-processing system including a data-processing device;
a transportation device;
the transportation device for each specified object type has at least one respective accommodation area to accommodate objects of this object type to be transported;
the transportation device configured with a respective accommodation area for accommodating each object of a respective object type to be transported in or on an accommodation area for this object type, and is configured for travelling to each destination to which at least one object is to be transported, and such that at the respective destination, each object for this destination may be removed from the transportation device;
the central data-processing system is configured:
to determine for each object the destination to which the object is to be transported;
to transmit the information to the data-processing device as to which destinations in each case at least one object is to be transported,
for each destination and each object type, to transmit the information as to whether no or at least one object of the object type is to be transported to this destination;
for each destination to which the transportation device travels, to output in human-ascertainable form the information as to which object types the objects which are to be transported to this destination belong.

9. The arrangement as claimed in claim 8, wherein the data-processing device is configured to voice output the information as to which object types of the objects are to be transported to a destination.

10. The arrangement as claimed in claim 8, wherein the data processing device is configured to be carried along by the transportation device during the transport of the objects to their destinations.

11. The method as claimed in claim 1, further comprising transporting the data processing device to the destination on the transportation device.
